(19) United States
(12) Patent Application Publication
(10) Pub. No.: US 2026/0050770 A1
(43) Pub. Date: Feb. 19, 2026

(54) SYSTEMS AND METHODS FOR TRAINING AND INFERENCE OF LARGE MULTIMODAL MODELS

(71) Applicant: Salesforce, Inc., San Francisco, CA (US)

(72) Inventors: Le Xue, Mountain View, CA (US); Manli Shu, Greenbelt, MD (US); Jun Wang, Palo Alto, CA (US); An Yan, Palo Alto, CA (US); Senthil Purushwalkam Shiva Prakash, Palo Alto, CA (US); Honglu Zhou, Palo Alto, CA (US); Viraj Prabhu, Bellevue, WA (US); Yutong Dai, Palo Alto, CA (US); Michael S Ryoo, New York, NY (US); Shrikant Kendre, Palo Alto, CA (US); Can Qin, Somerville, MA (US); Juntao Tan, Palo Alto, CA (US); Tulika Manoj Awalgaonkar, Mountain View, CA (US); Shelby Heinecke, San Francisco, CA (US); Huan Wang, Palo Alto, CA (US); Zeyuan Chen, Mountain View, CA (US); Silvio Savarese, Palo Alto, CA (US); Juan Carlos Niebles Duque, Mountain View, CA (US); Caiming Xiong, Menlo Park, CA (US); Ran Xu, Mountain View, CA (US)

(21) Appl. No.: 19/041,764

(22) Filed: Jan. 30, 2025

Related U.S. Application Data
(60) Provisional application No. 63/683,828, filed on Aug. 16, 2024.

(51) Int. Cl. G06N 3/0455; G06F 40/284; G06F 40/40; G06N 3/084; G06N 3/096; G06V 10/774; G06V 10/776; G06V 10/82

(52) U.S. Cl. CPC G06N 3/0455; G06F 40/284; G06F 40/40; G06N 3/084; G06N 3/096; G06V 10/774; G06V 10/776; G06V 10/82

(57) ABSTRACT

Embodiments described herein provide a method of performing a vision-language task by a neural network multimodal model in response to multiple input images, the method comprising: receiving, via a data interface, a text input and an image input; generating text tokens based on the text input; generating a plurality of image patches, wherein each image patch of the plurality of image patches includes a portion of the image input at substantially a same resolution as the image input; generating a downsized image based on a downsizing of the image input; generating vision tokens based on the plurality of image patches and the downsized image; generating, via a neural network based language model, an output based on the text tokens and the vision tokens; and updating parameters of the neural network based language model based on a loss objective based on the output.

### CROSS REFERENCE(S)

The application is s nonprovisional of and claims priority under 35 U.S.C. 119 to U.S. provisional application No. 63/683,828, filed Aug. 16, 2024, which is hereby expressly incorporated by reference herein in its entirety.

### TECHNICAL FIELD

The embodiments relate generally to machine learning systems for large multimodal models, and more specifically to the training and inference of large multimodal models.

### BACKGROUND

AI agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Some AI agents may generate a response to different types of user utterances. For example, in autonomous driving or other navigational, surveillance systems, an AI agent may intake a user query and input visual data such as an image or a live video stream of the surrounding, and the user query describes a task request relating to the image or the live video stream, e.g., to analyze the image content, to answer a question based on the visual data, and/or the like. Such AI agents may employ Large Multimodal Models (LMMs) to make predictions (e.g., an output text) based on multimodal inputs (e.g., text and images). Existing LMMs mostly employ intricate architectures to bridge vision and language modalities, and often require complex training objectives. Large-scale training of such LMMs can be computationally expensive and time-consuming, thus rendering the LMM less scalable. Moreover, existing LMMs can support only a single-image input at each inference, largely limiting their applicability and efficiency in applications such as medical diagnostics using medical images, autonomous driving using camera images from different angles of the surrounding environment, and/or the like.

### BRIEF DESCRIPTION OF THE DRAWINGS

FIGS. 1A-1B provide simplified block diagrams illustrating example user interface (UI) diagrams illustrating an AI agent built on an LMM interacting with a user, according to embodiments described herein.

FIG. 1C is a simplified diagram illustrating an overview of a training framework to train a multimodal model with multimodal interleaved data to generate a response to interleaved user inputs as shown in FIGS. 1A-1B, according to some embodiments.

FIG. 2 is a simplified diagram illustrating aspects of training framework shown in FIG. 1C, according to some embodiments.

FIGS. 3A-3C are simplified diagrams illustrating example pretraining datasets used in training framework in FIGS. 1C and 2, according to embodiments described herein.

FIG. 4 is a simplified diagram illustrating a computing device implementing the multimodal model framework described in FIG. 1A-2, according to some embodiments.

FIG. 5 is a simplified diagram illustrating a neural network structure, according to some embodiments.

FIG. 6 is a simplified block diagram of a networked system suitable for implementing the multimodal model framework described in FIGS. 1-5 and other embodiments described herein.

FIG. 7 is an example logic flow diagram illustrating a method of training a multimodal model based on the framework shown in FIGS. 1-6, according to some embodiments.

FIGS. 8-11 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

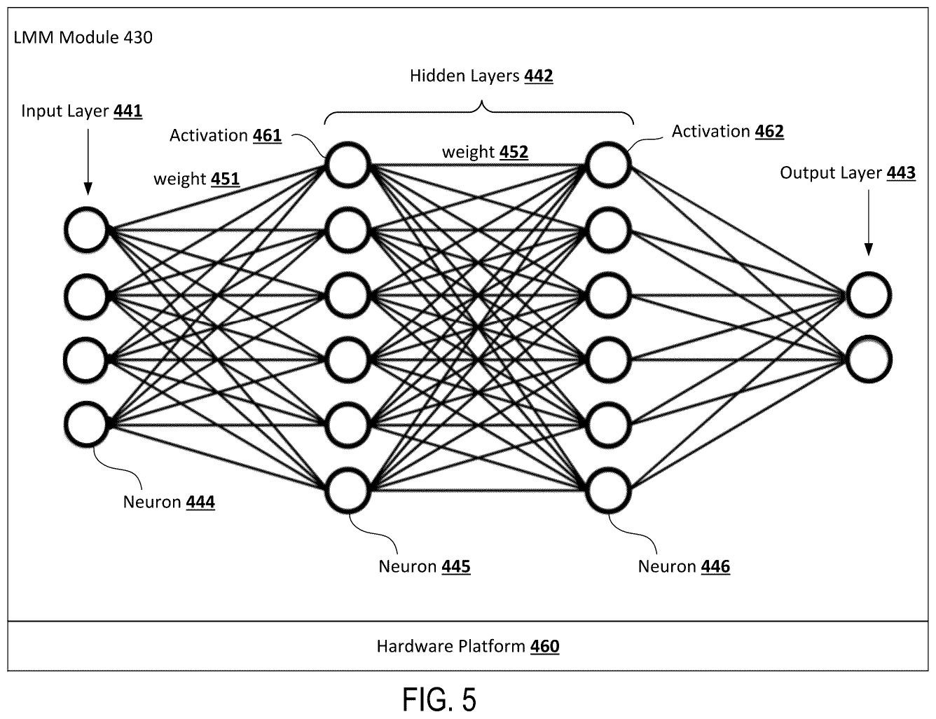

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

AI agents may generate a response to different types of user utterances. For example, in autonomous driving or other navigational, surveillance systems, an AI agent may intake a user query and input visual data such as an image or a live video stream of the surrounding, and the user query describes a task request relating to the image or the live video stream, e.g., to analyze the image content, to answer a question based on the visual data, and/or the like. Such AI agents may employ Large Multimodal Models (LMMs) that are models that may make predictions (e.g., an output text) based on multimodal inputs (e.g., text and images). LLMs have attracted significant attention with their potential applications and emergent capabilities. Existing methods employ intricate architectures to bridge vision and language modalities, coupled with complex training objectives, both of which pose obstacles for larger-scale training. Moreover, existing methods support only single-image input at each inference, largely limiting their applicability and efficiency in applications. For example, in medical diagnostics, multiple medical image scans may often be jointly read and understood to assist diagnostics. For another example, in an autonomous driving system, multiple images captured from different angles of the surrounding environment may often be jointly analyzed so as to detect the traffic condition and surroundings of the autonomous vehicle, so as to make a navigational command.

In view of the need for improved systems and methods for LMMs, embodiments described herein provide a training framework utilizing an ensemble of multimodal interleaved datasets, curated caption datasets, and other publicly available datasets to train an LMM. For example, the LMM architecture comprises a vision token sampler to generate vision tokens based on input images that are compatible to use as inputs to a neural network based language model. The LMM may be trained by the auto-regressive loss of text tokens. The model is trained on large-scale and high-quality datasets, such as a trillion-token scale interleaved dataset, and a knowledge-augmented high-quality dense captions dataset.

For example, the multiple vision transformers, token samplers, text tokenizers and LLM are neural network based models, and each instance may be a distinct model (e.g., with the same or different parameters), or the same model may be used for different inputs, with the outputs concatenated for the input to the pretrained LLM. In some embodiments, rather than concatenating the inputs to the LLM, each input may be input individually to the LLM.

In some embodiments, the vision transformer is pretrained and the parameters are frozen during training of the LMM. The output of the vision transformer is input to a vision token sampler. The token vision token sampler samples tokens to provide the output vision tokens. In parallel, input text is tokenized via a text tokenizer to provide text tokens. Multiple images and text inputs may be input via multiple vision transformer and text tokenizer inputs. The pretrained LLM may output vision tokens and/or text tokens in response to the inputs. In some embodiments, during one or more training stages, a loss is computed based on the output text token(s). Parameters of the vision token sampler(s), pretrained LLM, and/or other components of the LMM may be updated via backpropagation based on the computed loss. In some embodiments, the model is trained on large-scale and high-quality datasets, such as a trillion-token scale interleaved dataset, and a knowledge-augmented high-quality dense captions dataset.

Embodiments described herein provide a number of benefits. For example, improved performance for multimodal in-context learning compared to other LMMS, improved captioning accuracy, and other metrics as described with respect to FIGS. 5-14. Further, the model allows for multiple images to be used as the input. An LMM as described herein may be utilized in automating certain vision-based tasks (e.g., performing quality control, annotating visual data, analyzing medical images, etc.) Therefore, with improved performance on LMM performance, neural network technology in vision-language tasks including in manufacturing, medical, autonomous driving, surveillance, and other fields is improved.

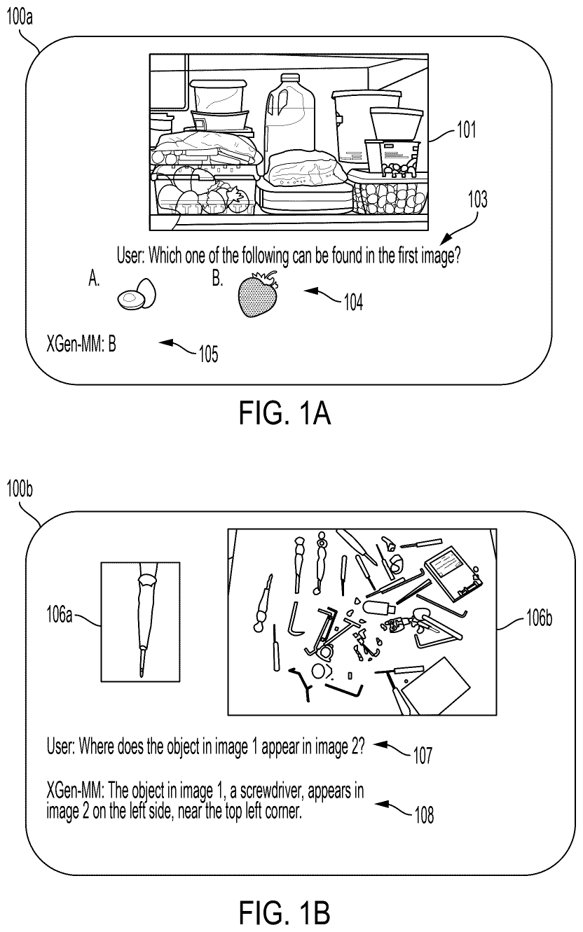

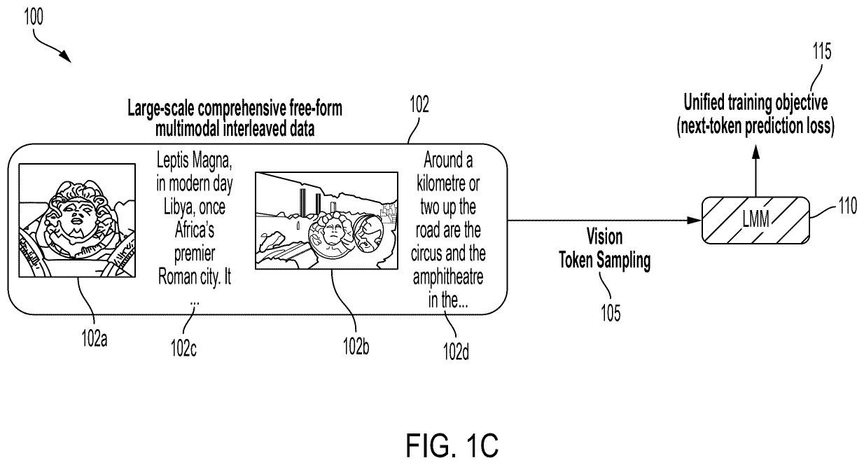

FIGS. 1A-1B provide simplified block diagrams illustrating example user interface (UI) diagrams 100a-100b illustrating an AI agent built on an LMM interacting with a user, according to embodiments described herein. As shown in FIGS. 1A-1B, for example, via a chat-based UI format, a user may enter interleaved image-text inputs and user queries about multiple images, and the AI agent (shown as “XGen-MM”) may in turn provide a response to the user query.

For example, as shown in FIG. 1A, a user input may comprise at least an input image 101, a text query 103, and multiple image icons (emojis) 104. An underlying LMM of the AI agent UI 100a may in turn process the interleaved user inputs of different modalities 103, 103, 104 and provides an output 105. The response output 105 is generated by an underlying LMM processing and understanding the relationships between the input items of different modalities, such as between objects in the input image 101, words and/or terms in the query 103 (e.g., “which,” “one of,” “following,” “first image”), and each emoji icon 104, and generates a response as choosing “one of” the provided emoji icons 104.

For another example, as shown in FIG. 1B, a user input may comprise at least two input images 106a-106b, and a text query 107. An underlying LMM of the AI agent UI 100a may in turn process the interleaved user inputs of different modalities 106a-b and 107 to provide an output 108. The response output 108 is generated by an underlying LMM processing and understanding the relationships between the input items of different modalities, such as between the objects in image 106a, objects in image 106b and the key words in query 107 (e.g., “object,” “image 1,” “image 2”).

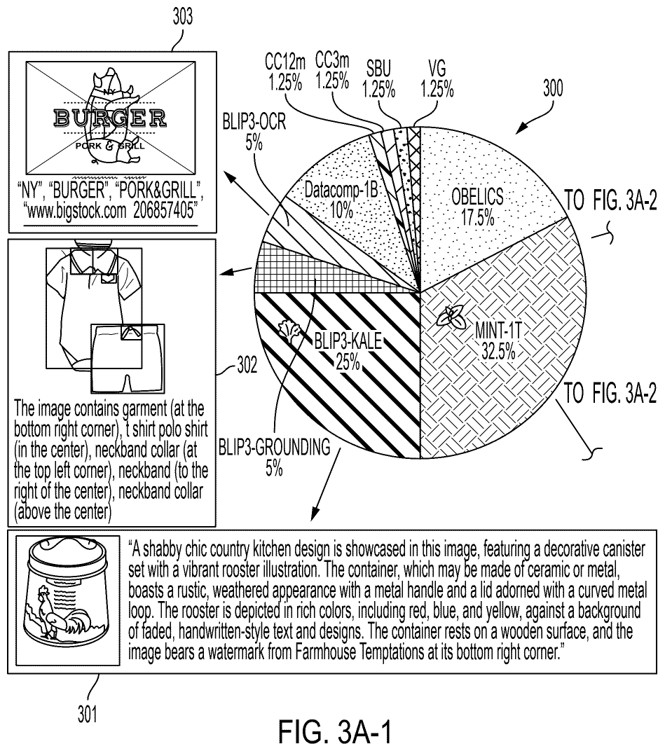

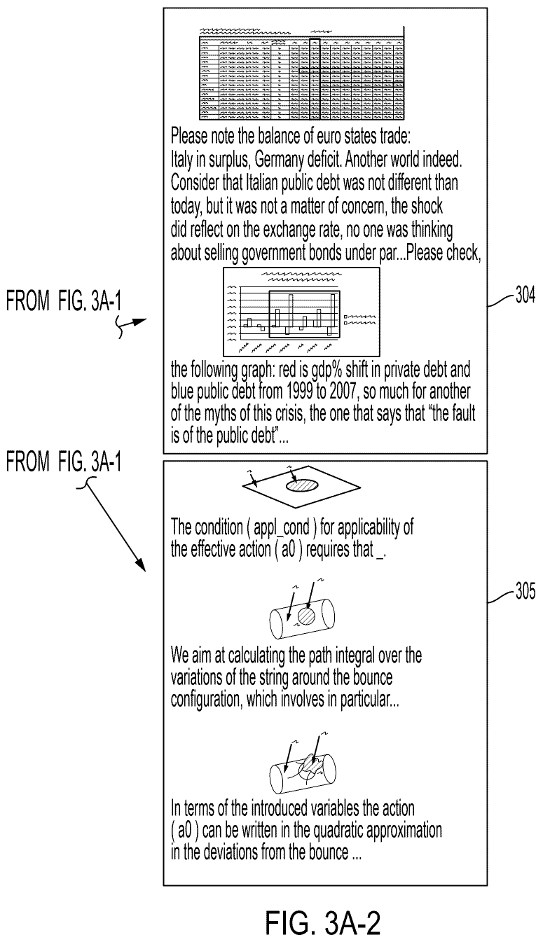

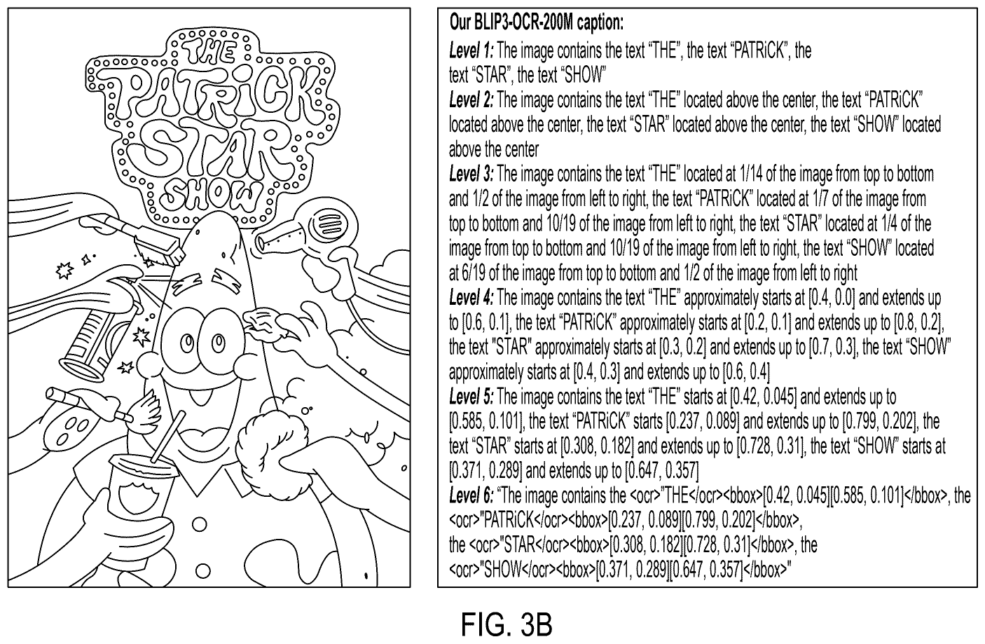

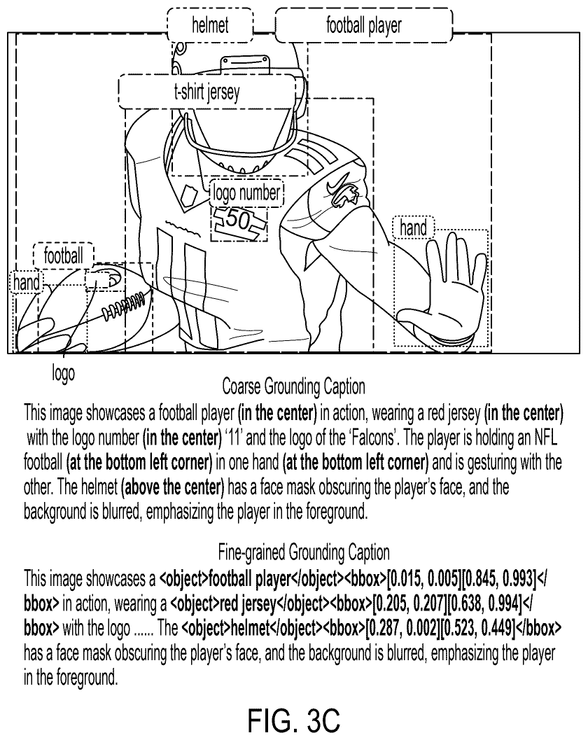

FIG. 1C is a simplified diagram illustrating an overview of a training framework 100 to train a multimodal model with multimodal interleaved data to generate a response to interleaved user inputs as shown in FIGS. 1A-1B, according to some embodiments. In one embodiment, an LMM 110 may be trained with a large-scale dataset of comprehensive free-form multimodal interleaved data 102. For example, the multimodal interleaved data 102 may comprise images 102a-102b and accompanying texts 102a-102d. Additional examples of the multimodal interleaved data 102 may be described in FIGS. 3A-3C.

In one embodiment, vision token sampling 105 may be applied to process the multimodal interleaved data 102 before such is fed to the LMM 110 to generate a training output. For example, the LMM 110 may generate an output response by predicting a next token, which may then be used to compute a prediction loss 115. The prediction loss 115 may be a unified training objective at every training stage for the multimodal tasks. In this way, training of LMM 110 on different multimodal tasks may be unified, and computational efficiency of training is thus improved.

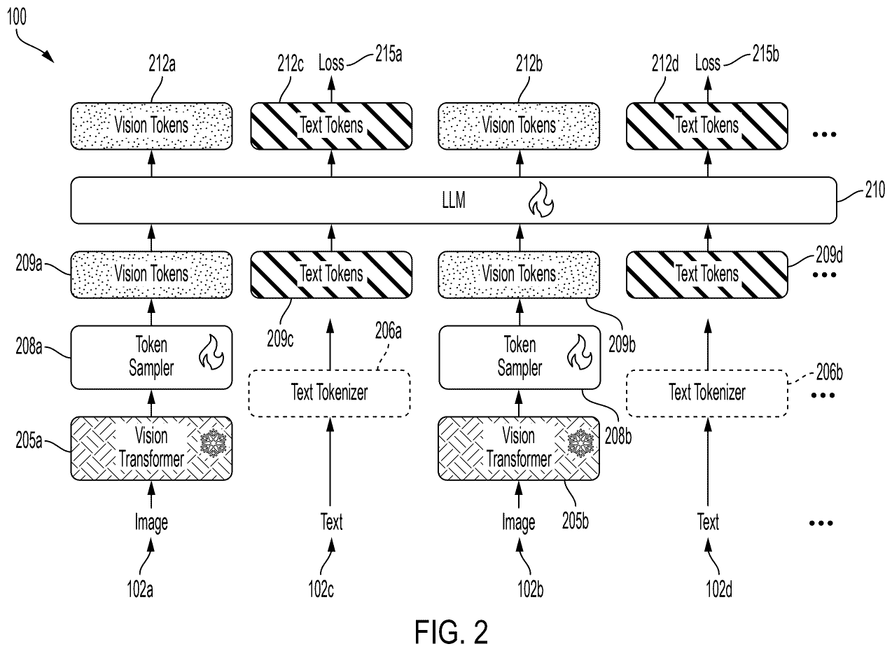

FIG. 2 is a simplified diagram illustrating aspects of training framework 100 shown in FIG. 1C, according to some embodiments. In one embodiment, LMM 110 (as shown in FIG. 1C) may comprise one or more vision transformers 205a-b, one or more vision token samplers 208a-b, one or more text tokenizers 206a-b, an LLM 210, and/or the like.

In one embodiment, LLM 210 and/or token samplers 208a-208b may be updated during multiple stages of training while vision transformers 205a-b may remain unchanged (frozen). The training may comprise multiple stages, such as a pre-training stage using image-caption pairs, a first finetuning stage using image question-answer pairs with a single input image, and a second finetuning stage using image question answer pairs with multiple input image.

In one embodiment, at the pretraining stage, input training data 120a-102d may comprise freeform multimodal interleaved texts and images, such as images 102a-102b describing different aspects of a scene or an object, and accompany texts (captions) 102c-d associated with the images 102a-b, respectively. Example pretraining datasets may be described in FIGS. 3A-3C.

Each of vision transformers 205a-b may adopt a structure similar to the vision transformers described in Zhai et el., Sigmoid loss for language image pre-training, in Proceedings of the IEEE/CVF International Conference on Computer Vision, pages 11975-11986, 2023. Vision transformers 205a-b may convert input images 102a-102b into image embeddings (tokens), respectively.

For example, each input image 102a-b may be split into image patches, and the image patches may be separately encoded at the vision transformer 205a-205b into patch embeddings. In this way, the patch-wise encoding may preserve the resolution of patches of higher resolution such that higher-resolution image understanding can be achieved. The encoded image patch embeddings may then be concatenated with a downsized original image that provides global information.

In one embodiment, token samplers 208a-208b may receive image (patch) embeddings from the vision transformers 205a-b, respectively, and down sample the image embeddings. For example, the perceiver resampler (described in Alyrac et al., Flamingo: a visual language model for few-shot learning, in proceedings of NeurIPS, 2022) may be adopted as the token sampler 208a-b, which downsamples the image embeddings (tokens). For instance, a Perceiver-Resampler may adapt the high-dimensional visual tokens from image encoders 205a-n to a fixed-size (e.g., N=128) learnable latent representation. A cross-attention mechanism at the Resampler may use the learnable latent queries to the high-dimensional input visual tokens. Each latent query gathers relevant information from the input visual tokens based on attention weights. In this way, fixed-size latent representation may be computed as a weighted sum of the input tokens, with the attention weights. The latent representation thus summarizes the input data resulting in a lower dimensional representation.

Each image patch (including the downsized original image) embedding may be downsampled independently. The downsampled vision tokens 209a-209b are then concatenated together and sent to the LLM 210. With the downsampling, the sequence length of vision tokens may be reduced by a factor of five or more depending on the number of query tokens in the perceiver resampler, largely reduced computational complexity.

In one embodiment, text input 102c-d may be sent to text tokenizers 206a-b to convert into text tokens 209c-d, respectively. The (downsampled) vision tokens 209a-b and text tokens 209c-d may be concatenated and input to a LLM 210.

In some embodiments, the LLM 210 may comprise a Transformer encoder and a Transformer decoder, or a decoder-only structure. Decoder of LLM 210 may autoregressively predict a next token conditioned on the input tokens 209a-d. At pretraining stage, LLM 210 may output predicted vision tokens 212a, predicted text tokens 212c, vision tokens 212b, text tokens 212d that attempt to reconstruct input tokens 209a-d. Additional details on how a Transformer-based LLM predicts a next token is further described in relation to FIG. 5.

At pretraining stage, among the reconstructed output tokens 212a-d, text tokens 212c and/or 212d may be compared with the input tokens 209c-d, respectively, to compute one or more cross entropy losses 215a-b. The pretraining losses 215a-b are thus used to update weights and/or parameters of LLM 210 and/or token samplers 208a-b while vision transformers 205a-b remain frozen.

For instance, the LLM 210 may be pre-trained for about 100 billion multimodal tokens from the ensembled datasets described in FIGS. 3A-3C, and the pre-training resolution is 384×384 pixels.

In one embodiment, the pretrained LLM 210 may then be fine-tuned with supervised fine-tuning (SFT), e.g., based on image question answering tasks. For example, training samples of images and questions may be fed, similar to images 102a-b and texts 102c-d to framework 100. LLM 210 may in turn generate training output text tokens representing an answer to the question based on the input image. The predicted answer may then be used to compute a cross-entropy losses 215a-b comparing the predicted answer and ground truth answer in the training data. The loss may then be used to finetune LLM 210 and/or token samplers 208a-b while weights and parameters of vision transformers 205a-b remain unchanged (“frozen”).

For example, training framework 100 may first fine-tune LLM 210 using a collection of publicly available instruction-following datasets (e.g., Laurencon et al., What matters when building vision-language models, 2024, arxiv 2405.02246, 2024). For instance, training samples may be drawn from various domains including multi-modal conversation, image captioning, visual question answering, chart/document understanding, science and math, and/or the like. In addition to the multi-modal image-text data, pure text instruction following data may be mixed during visual instruction tuning.

In one embodiment, after single-image SFT, a second-stage fine-tuning may use a mixture of multi-image and single-image instructions-following samples. For example, the image-instruction tuning stage starts with a model fine-tuned on single-image samples. A mixture of public multi-image/interleaved image-text instruction data (Jiang et al., MANTIS: Interleaved Multi-Image Instruction Tuning, arXiv: 2405.01483, 2024) may be used. To prevent the LLM 210 from deteriorating on single-image capabilities, a subset of single-image datasets used in the previous fine-tuning stage and mix them into the multi-image training data. The second-stage fine-tuning may enhance LLM's ability to comprehend interleaved image-text input, which is helpful for multimodal in-context learning, multi-image question answering, and many more practical use cases.

In one embodiment, post-training, additional multimodal preference dataset may further tune LLM 210 to generate responses to a mix of multimodal instructions and the responses are then scored by a vision-language model such as GPT4-V along three axes-helpfulness, visual faithfulness, and ethics. For example, 1 epoch of direct preference optimization may be performed on the combined preference dataset while updating a subset (2.5%) of LLM backbone weights using low-rank adaptation. An additional set of responses that capture the model's intrinsic hallucinations, by performing a second step of DPO per-iteration against the models' output to a noised version of the input image and original query, which is treated as an additional dispreferred response.

Next, 3 epochs of safety fine-tuning may be performed on a dataset containing unsafe images and instructions. Such dataset may comprise two types of unsafe examples: (1) objectionable images paired with safe instructions and a desirable abstention response, and (2) safe images paired with two types of instruction-response pairs, one safe and another unsafe. The dataset consists of unsafe examples belonging to various subcategories including privacy-violating, risky/sensitive topics (such as politics, sex, and violence), deception, and discrimination. For example, additional examples may be randomly sampled from the instruction fine-tuning dataset to retain the model's helpfulness without exaggerating its safety behavior.

FIG. 3A is a simplified diagram illustrating an example overview of pretraining datasets used in training framework 100 in FIGS. 1C and 2, according to embodiments described herein. Dataset 300 comprise an ensemble of diverse multimodal datasets with the respective sampling ratios as shown in FIG. 3A.

For example, dataset 300 comprise MINT-1T dataset 304-305 (including its HTML, PDF, and ArXiv subsets) with OBELICS dataset (HTML only) to create a more diverse and comprehensive dataset mixture that covers a broader range of domains. For example, MINT-1T (Anas et al., Mint-1t: Scaling open-source multimodal data by 10x: A multimodal dataset with one trillion tokens. arXiv preprint arXiv:2406.11271, 2024) is a trillion token scale multimodal interleaved dataset, containing data sources from HTML, PDF, and ArXiv. Example image-text samples of MINT-1T may be shown at 304-305. MINT-1T has three subsets from different sources: the HTML subset, the PDF subset, and the ArXiv subset. In one implementation, these three subsets are mixed in a 7:5:1 ratio in dataset 300.

For another example, OBELICS (Laurencon et al., What matters when building vision-language models?, arXiv: 2405.02246, 2024 2024) is another large-scale multimodal interleaved dataset constructed from HTML documents solely. It differs slightly in domain coverage from MINT-1T due to the specific preprocessing steps adopted.

In one embodiment, dataset 300 further comprise a diverse range of caption datasets. For example, BLIP3-KALE is a large-scale curated high-quality caption dataset; and an image-text sample of BLIP3-KALE is provided at 301. BLIP3-OCR-200M is a curated large-scale OCR dataset to address the limitations of current large multimodal models in handling text-rich images like documents and charts, as traditional image-text datasets often lack adequate OCR annotations. An example image-text sample of BLIP3-OCR is provided at 303.

To enhance text comprehension abilities, a dataset of 200 million high-resolution images from Datacomp-1B are used. For each image, captions are created with optical character recognition (OCR) data by identifying and extracting textual elements using the off-the-shelf OCR engine. Text segments in a caption like “ . . . text . . . ” are modified to include OCR information as “ . . . text (ocr_info) . . . ”, where ocr_info contains bounding box coordinates for the extracted text, specifying its exact position within the image in the format “<bbox>x1, y1, x2, y2</bbox>”.

In one embodiment, multiple granularities of OCR information, including with and without bounding box data are included. For example, only textual information without bounding box data may be utilized. For example, FIG. 3B shows an example image-text sample of six levels of OCR information granularity are extracted, with and without bounding box data. Note that OCR-related captions are preprocessed to remove filler phrases like ‘the text,’ resulting in improved OCR benchmark performance.

For another example, BLIP3-GROUNDING-50M is a curated large-scale grounding dataset to enhance the ability to ground semantic concepts in visual features, which is crucial for tasks like object detection, semantic segmentation, and understanding referring expressions (e.g., “the object to the left of the dog”). An example image-text sample of BLIP3-GROUNDING may be shown at 302. For each image, objects and their location information are identified by object detection models. Objects mentioned in a caption like “ . . . object . . . ” are modified to include grounding information as “ . . . object (grounding_info) . . . ”, where grounding_info contains bounding box information in one of three formats, each capturing a different granularity of localization: (1)<bbox>x1, y1, x2, y2</bbox>, (2) “starts at (x1, y1) and extends up to (x2, y2)”, or (3) “top-left corner of the image”. For example, FIG. 3C shows image-text samples from BLIP3-GROUNDING. A large-scale dataset of images and corresponding captions containing localization information about objects. Furthermore, the associated object bounding box data may be included to facilitate the creation of captions with custom templates.

### Computer and Network Environment

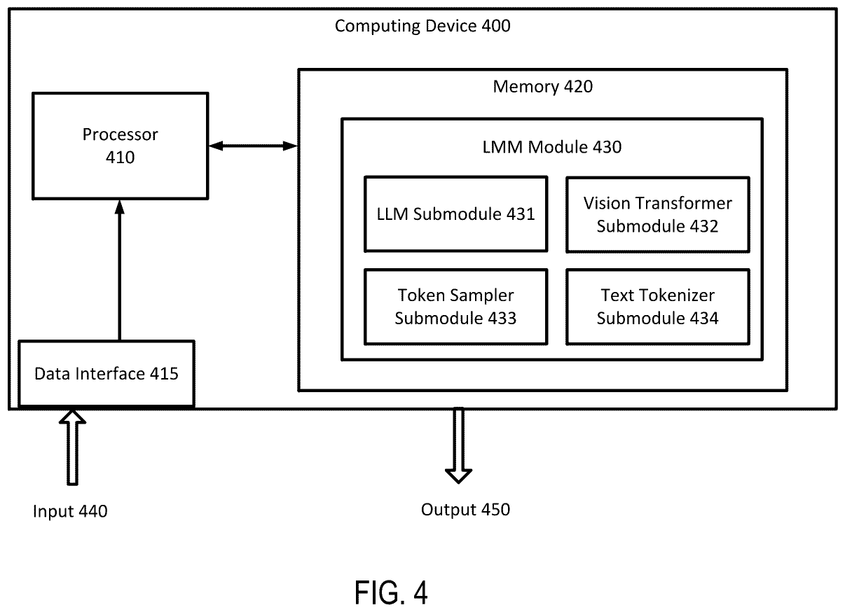

FIG. 4 is a simplified diagram illustrating a computing device implementing the multimodal model framework described in FIG. 1, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for LMM module 430 that may be used to implement and/or emulate the systems and models, and/or to implement any of the methods described further herein. LMM module 430 may receive input 440 such as an input training data (e.g., image/caption pairs, instructions, etc.) via the data interface 415 and generate an output 450 which may be a text output.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as text and images, from a user via the user interface.

In some embodiments, the LMM module 430 is configured to train and/or perform inference as described herein and in FIGS. 1C and 2. The LMM module 430 may further include LLM submodule 431 (e.g., similar to LLM 210 in FIG. 2), vision transformer submodule 432 (e.g., similar to 205a-b in FIG. 2), token sampler submodule 433 (e.g., similar to 208a-b in FIG. 2) and text tokenizer submodule 434 (e.g., 206a-b in FIG. 2).

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the LMM module 430 described in FIG. 4A, according to some embodiments. In some embodiments, the LMM module 430 and/or one or more of its submodules 431-232 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as text and images. The number of nodes (neurons) in the input layer 441 may be determined by the dimensionality of the input data (e.g., the length of a vector of the text and/or images). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the LMM module 430 receives an input 440 of text and images and transforms the input into an output 450 of a text response. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LMM module 430 and/or one or more of its submodules 431-232 may comprise the transformative neural network structure of layers of neurons, and weights and activation functions describing the non-linear transformation at each neuron. Such a neural network structure is often implemented on one or more hardware processors 410, such as a graphics processing unit (GPU).

In one embodiment, the LMM module 430 and its submodules 431-232 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the LMM module 430 and its submodules 431-434 may be implemented by hardware, software and/or a combination thereof. For example, the LMM module 430 and its submodules 431-434 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the LMM module 430 and its submodules 431-434 and/or any other neural network models onto hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the LMM module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the LMM module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the LMM module 430 and its submodules 431-232 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LMM module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based LMM module 430 and one or more of its submodules 431-232 may be trained by iteratively updating the underlying parameters (e.g., weights 451, 452, etc., bias parameters and/or coefficients in the activation functions 461, 462 associated with neurons) of the neural network based a loss function. For example, during forward propagation, the training data such as image/caption pairs are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding ground truth output text tokens) from the training data, to compute a loss function that measures the discrepancy between the predicted output and the expected output. For example, the loss function may be cross entropy, MMSE, etc. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based LMM module 430 and one or more of its submodules 431-232 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

In one embodiment, LMM module 430 and its submodules 431-232 may be housed at a centralized server (e.g., computing device 400) or one or more distributed servers. For example, one or more of LMM module 430 and its submodules 431-232 may be housed at external server(s). The different modules may be communicatively coupled by building one or more connections through application programming interfaces (APIs) for each respective module. Additional network environment for the distributed servers hosting different modules and/or submodules may be discussed in FIG. 3.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen images and text.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in large multimodal models.

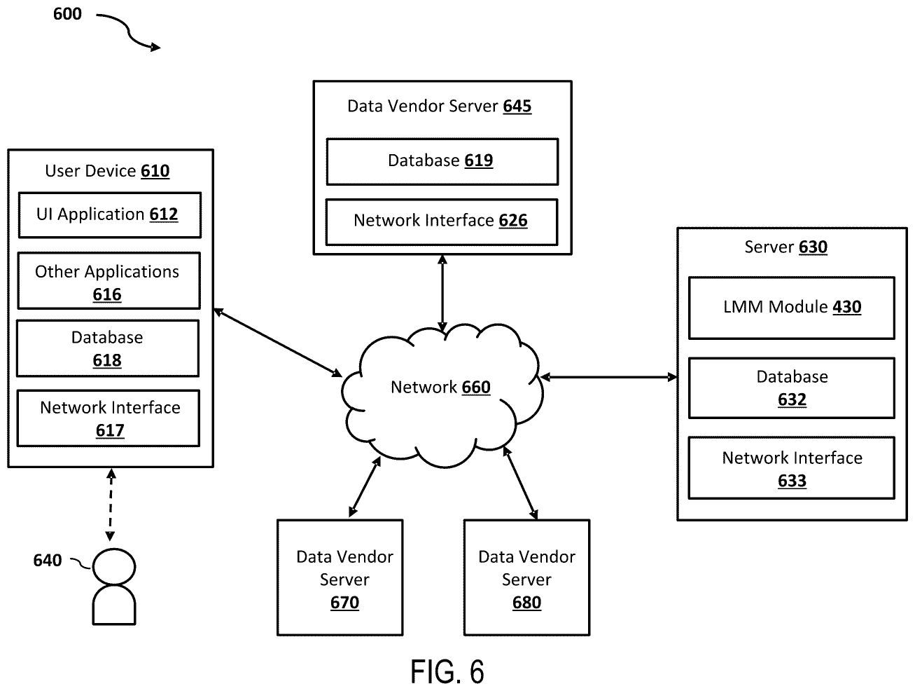

FIG. 6 is a simplified block diagram of a networked system 600 suitable for implementing the multimodal model framework described in FIGS. 1-2B and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a response from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the LMM module 230 at server 630. In at least one embodiment, a user operating user device 610 may enter a user utterance, e.g., via text or audio input, such as a question, uploading a document, and/or the like via the UI application 612. Such user utterance may be sent to server 630, at which LMM module 230 may generate a response via the process described in FIGS. 1-2B. The LMM module 230 may thus cause a display of a response at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view responses.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including images and text to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the LMM module 230 and its submodules described in FIG. 2A. In some implementations, LMM module 230 may receive data from database 619 at the data vendor server 645 via the network 660 to generate responses. The generated responses may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the LMM module 230. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

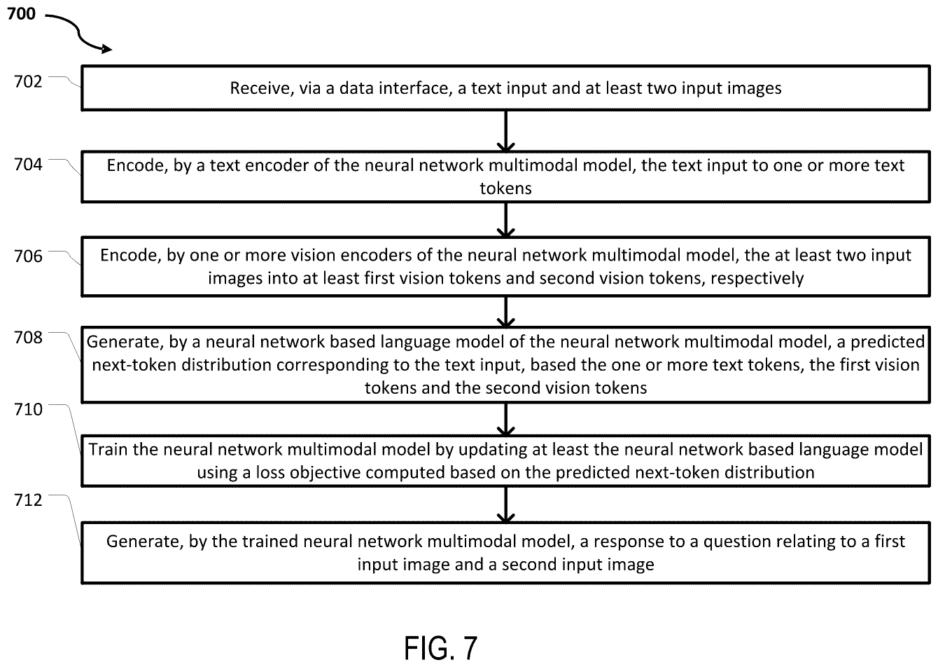

FIG. 7 is an example logic flow diagram illustrating a method of perform a vision-language task by a neural network multimodal model shown in FIGS. 1-6, in response to multiple input images, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the LMM module 430 that performs training and/or inference of an LMM.

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, a text input (e.g., 102c or 102d in FIG. 2) and at least two input images (e.g., 102a-b in FIG. 2) may be received, via a data interface (e.g., 415 in FIG. 4, 633 in FIG. 6).

At step 704, a text encoder (e.g., text tokenizer 206a-b in FIG. 2) of the neural network multimodal model may encode the text input to one or more text tokens (e.g., 209c-d in FIG. 2).

At step 706, one or more vision encoders (e.g., vision transformers 205a-b) of the neural network multimodal model may encode the at least two input images into at least first vision tokens (e.g., 212a in FIG. 2) and second vision tokens (e.g., 212b in FIG. 2), respectively. For example, for each of the two input images, a plurality of image patches may be generated. Each image patch of the plurality of image patches includes a portion of the each input image at substantially similar resolution. Thus, the first vision tokens and the second vision tokens are obtained by encoding, by the one or more vision encoders, the plurality of image patches into raw vision tokens. Then one or more token samplers (e.g., 208a-b in FIG. 2) may downsample the raw vision tokens corresponding to each image patch. The downsampled raw vision tokens may correspond to the first vision tokens and the second vision tokens corresponding to the at least two input images.

At step 708, a neural network based language model (e.g., LLM 210 in FIG. 2) of the neural network multimodal model may generate a predicted next-token distribution corresponding to the text input, based the one or more text tokens, the first vision tokens and the second vision tokens.

At step 710, the neural network multimodal model may be trained by updating at least the neural network based language model using a loss objective computed based on the predicted next-token distribution. For example, the training process of steps 702-710 may comprise multiple stages. A first stage of pre-training of the neural network based language model uses a first dataset of training images and corresponding texts (e.g., see dataset 300 in FIG. 3A). During pretraining, the predicted next-token distribution corresponds to reconstructed text tokens, and the loss objective comprises a first cross-entropy loss between the one or more text tokens the predicted next-token distribution. A second stage of fine-tuning the neural network based language model uses a second dataset of at least one training image, a question about the training image, and an answer to the question. The predicted next-token distribution corresponds to predicted text tokens of a predicted answer to the question, and the loss objective comprises a second cross-entropy loss between the predicted text tokens and the answer to the question. A third stage of fine-tuning the neural network based language model uses multiple image inputs, and a training question relating to the multiple image inputs.

At step 712, the trained neural network multimodal model may generate a response (e.g., 108 in FIG. 1B) to a question (e.g., 107 in FIG. 1B) relating to a first input image (e.g., 106a in FIG. 1B) and a second input image (e.g., 106b in FIG. 1B).

In one embodiment, method 700 may be applied to an AI agent in a variety of other vision-language related tasks. For example, in healthcare, the text input may comprise a doctor's inquiry to identify particular patterns and the image input may comprise multiple medical images. The neural network based language model may thus be trained using method 700 to generate a diagnostic result, such that a medical professional may associate a treatment plan with the AI generated diagnostic result. For another example, in autonomous driving, the text input may comprise an inquiry relating to a surrounding of an autonomous vehicle, and the image input may comprise multiple video frames capturing the surroundings. The neural network based language model may thus be trained using method 700 to generate a control command to be sent to the control mechanism of the autonomous vehicle to steer a direction and driving of the vehicle.

### Example Data Experiments

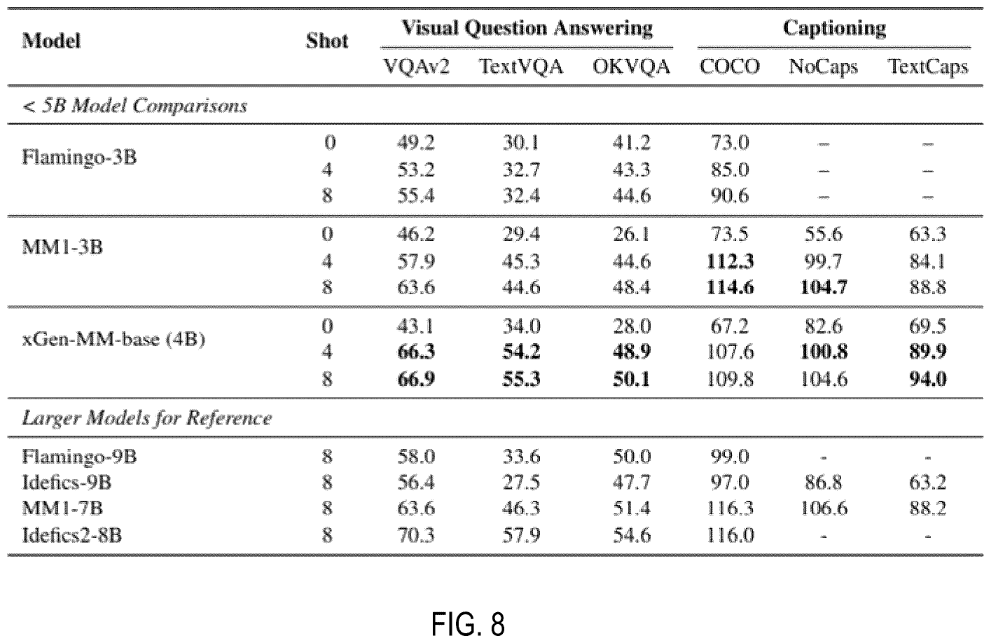

FIGS. 8-11 represent exemplary test results using embodiments described herein. Experiments whose results are illustrated represent performance at different stages (e.g., after pre-training, after supervised fine-tuning, etc.).

Baseline models used for comparison include: Flamingo-3B as described in Alayrac et al., Flamingo: a visual language model for few-show learning, NeurIPS, 2022; MM1-3B as described in McKinzie et al., MM1: Methods, Analysis & Insights from Multimodal LLM Pre-training, arXiv: 2403.09611, 2024; GPT-4; HPT-1.5-Edge; VILA-1.5-3B; and Phi-3-vision. In the charts, models that are trained according to embodiments described herein are labeled as “Xgen.” In some charts, an “interleaved” embodiment is included in the comparisons in which the model is fine-tuned on interleaved multi-image datasets (i.e. datasets in which images are interspersed with text, as in certain news and blog sources).

Datasets used in benchmarking include COCO (including Caps for image-text tasks, NoCaps for OCR tasks, and TextCaps variants); VQA as described in Schwenk et al., A-okvqa: A benchmark for visual question answering using world knowledge, Computer Vision—ECCV 2022: 17th European Conference, Proceedings, Part VIII, pp. 146-162, 2022. Additional benchmarks and metrics are described with reference to their Figures in which performance is illustrated. Metrics include CIDEr score (consensus-based image description evaluation) which measures the similarity of a generated sentence against a set of ground truth sentences written by humans.

FIG. 8 illustrates a few-shot pretraining evaluation in which examples were randomly sampled from the training set as few-shot examples. Results are reported in CIDER score for captioning and accuracy for VQA. After the pretraining stage, the pretrained LMM was evaluated on classic captioning and visual question answering (VQA) tasks, in comparison with baseline models that support few-shot learning multi-modal evaluation. Zero-shot and few-shot (e.g., 4- and 8-shots) results are illustrated in FIG. 5. As illustrated, the model achieves competitive multimodal in-context learning performance with comparable-sized LMMs.

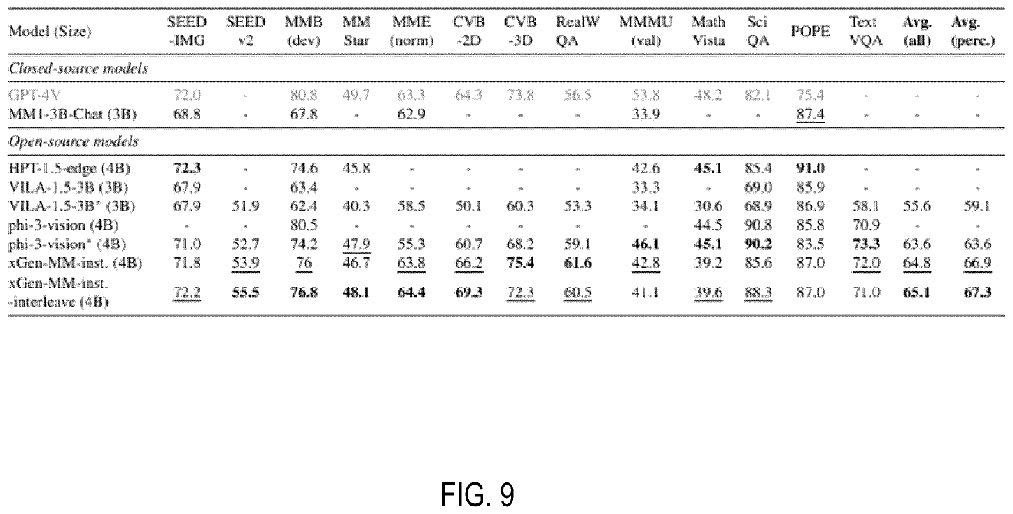

FIG. 9 illustrates evaluation on single-image benchmarks. Benchmarks include VQA benchmarks, visual perception, domain knowledge, OCR ability, and hallucination. For models fine-tuned on interleaved multi-image datasets, performance was also evaluated on common multi-image benchmarks. The benchmarks are described in Li et al., Seed-bench: Benchmarking multimodal Ilms with generative comprehension, arXiv: 2307.16125, 2023; Liu et al., Mmbench: Is your multi-modal model an all-around player?, arXiv: 2307.06281, 2023; Fu et al., MME: A comprehensive evaluation benchmark for multimodal large language models, CoRR, abs/2306.13394, 2023; Chen et al., Are we on the right way for evaluating large vision-language models?, arXiv: 2403.20330, 2024; Tong et al., Cambrian-1: A fully open, Vision-centric exploration of multimodal LLMs, arXiv: 2406.16860, 2024; Yue et al., MMMU: A massive multi-discipline multimodal understanding and reasoning benchmark for expert AGI, CoRR, abs/2311.16502, 2023; Lu et al., Mathvista: Evaluating mathematical reasoning of foundation models in visual contexts, International Conference on Learning Representations (ICLR), 2024; Singh et al., Towards VQA models that can read, Proceedings of the IEEE Conference on Computer Vision and Pattern Recognition, pp. 8317-8326, 2019; Liu et al., On the hidden mystery of OCR in large multimodal models, arXiv: 2305.07895, 2024; Guan et al., Hallusionbench: an advanced diagnostic suite for entangled language hallucination and visual illusion in large vision-language models, Proceedings of the IEEE/CVF Conference on Computer Vision and Pattern Recognition, pp. 14375-14385, 2024; Li et al., Evaluating object hallucination in large vision-language models, The 2023 Conference on Empirical Methods in Natural Language Processing, 2023; Jiang et al., MANTIS: Interleaved Multi-Image Instruction Tuning, arXiv: 2405.01483, 2024; Wu et al., Q-bench: A benchmark for general-purpose foundation models on low-level vision, ICLR, 2024; Wang et al., Muirbench: A comprehensive benchmark for robust multi-image understanding, CoRR, abs/2406.09411, 2024; and Fu et al., BLINK: multimodal large language models can see but not perceive, CoRR, abs.2404.12390, 2024.

As illustrated in FIG. 9, models with comparable sizes (<5B parameters) were used for comparison, including both closed-source and open-source models. The model described herein (XGen-MM-inst) outperforms previous baselines on both general VQA and visual perception benchmarks. In addition, the model, although further fine-tuned on multi-image data, maintains good performance on single-image benchmarks and has the highest overall scores.

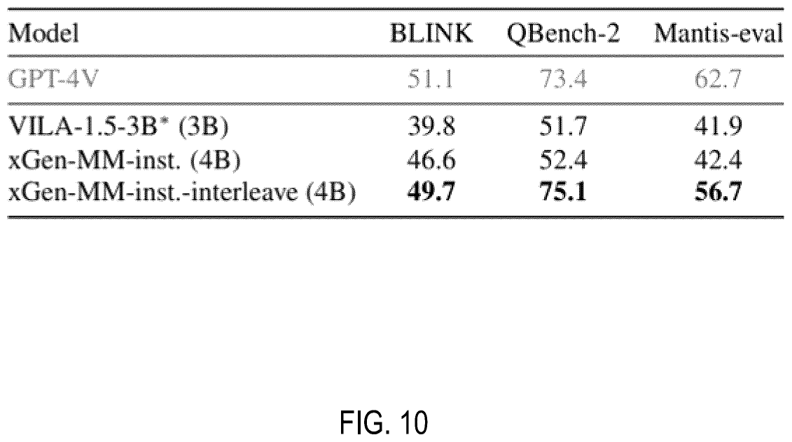

FIG. 10 illustrates an evaluation on multi-image benchmarks. These benchmarks include BLINK as described in Fu et al., BLINK: multimodal large language models can see but not perceive, CoRR, abs.2404.12390, 2024; QBench-2; MuirBench as described in Wang et al., Muirbench: A comprehensive benchmark for robust multi-image understanding, CoRR, abs/2406.09411, 2024; and Mantis-eval as described in Jiang et al., MANTIS: Interleaved Multi-Image Instruction Tuning, arXiv: 2405.01483, 2024. As illustrated in FIG. 7, with multi-image supervised fine-tuning, scores improve significantly.

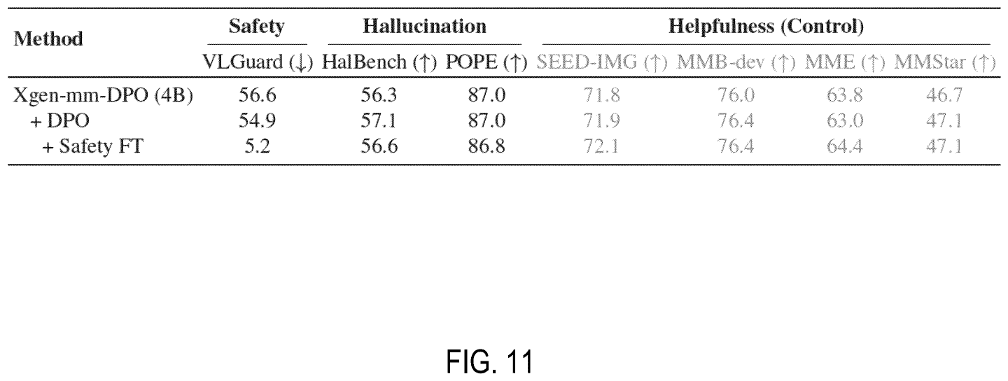

FIG. 11 illustrates post-training results. Results are reported on safety and hallucination benchmarks after post-training, as well as on four helpfulness benchmarks as a control. Post-training improves harmlessness without compromising helpfulness. Specifically, FIG. 8 illustrates results o two post-training strategies (DPO and Safety FT). Safety performance is measured by attack success rate (ASR) on the VLGuard test-split and hallucination performance using Hallusion Bench (accuracy on image-context reasoning) and POPE (average F1 score on binary entity presence questions). To ensure post-training doesn't compromise helpfulness, performance on SEED-IMG and MMBench are included as a control. These benchmarks are described in: Guan et al., Hallusionbench: an advanced diagnostic suite for entangled language hallucination and visual illusion in large vision-language models, Proceedings of the IEEE/CVF Conference on Computer Vision and Pattern Recognition, pp. 14375-14385, 2024; Li et al., Evaluating object hallucination in large vision-language models, The 2023 Conference on Empirical Methods in Natural Language Processing, 2023; Li et al., Seed-bench: Benchmarking multimodal Ilms with generative comprehension, arXiv: 2307.16125, 2023; and Liu et al., Mmbench: Is your multi-modal model an all-around player?, arXiv: 2307.06281, 2023.

As illustrated, DPO enhances truthfulness by improving hallucination benchmarks (row 2), while safety finetuning significantly reduces ASR (row 3). Helpfulness is also improved slightly, as shown by control benchmarks.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of performing a vision-language task by a neural network multimodal model in response to multiple input images, the method comprising:
receiving, via a data interface, a text input and at least two input images;
encoding, by a text encoder of the neural network multimodal model, the text input to one or more text tokens;
encoding, by one or more vision encoders of the neural network multimodal model, the at least two input images into at least first vision tokens and second vision tokens, respectively;
generating, by a neural network based language model of the neural network multimodal model, a predicted next-token distribution corresponding to the text input, based the one or more text tokens, the first vision tokens and the second vision tokens;
training the neural network multimodal model by updating at least the neural network based language model using a loss objective computed based on the predicted next-token distribution; and
generating, by the trained neural network multimodal model, a response to a question relating to a first input image and a second input image.

2. The method of claim 1, further comprising:
generating, for each of the two input images, a plurality of image patches, wherein each image patch of the plurality of image patches includes a portion of the each input image at substantially similar resolution,
wherein the first vision tokens and the second vision tokens are obtained by: encoding, by the one or more vision encoders, the plurality of image patches into raw vision tokens.

3. The method of claim 2, further comprising:
downsampling, by one or more token samplers, the raw vision tokens corresponding to each image patch, and
concatenating the downsampled raw vision tokens into the first vision tokens and the second vision tokens corresponding to the at least two input images.

4. The method of claim 3, wherein the training neural network multimodal model further comprises:
updating the neural network based language model and the one or more token samplers based on the loss objective via backpropagation while keeping the one or more vision Transformers unchanged.

5. The method of claim 1, wherein the training neural network multimodal model further comprises:
a first stage of pre-training the neural network based language model using a first dataset of training images and corresponding texts, wherein the predicted next-token distribution corresponds to reconstructed text tokens, and the loss objective comprises a first cross-entropy loss between the one or more text tokens the predicted next-token distribution.

6. The method of claim 5, wherein the training neural network multimodal model further comprises:
a second stage of fine-tuning the neural network based language model using a second dataset of at least one training image, a question about the training image, and an answer to the question, wherein the predicted next-token distribution corresponds to predicted text tokens of a predicted answer to the question, and the loss objective comprises a second cross-entropy loss between the predicted text tokens and the answer to the question.

7. The method of claim 6, wherein the training neural network multimodal model further comprises:
a third stage of fine-tuning the neural network based language model using multiple image inputs, and a training question relating to the multiple image inputs.

8. A system of performing a vision-language task by a neural network multimodal model in response to multiple input images, the method comprising:
a data interface receiving a text input and at least two input images;
a memory storing a plurality of processor-executable instructions; and
one or more processors executing the plurality of processor-executable instructions to perform operations comprising:
encoding, by a text encoder of the neural network multimodal model, the text input to one or more text tokens;
encoding, by one or more vision encoders of the neural network multimodal model, the at least two input images into at least first vision tokens and second vision tokens, respectively;
generating, by a neural network based language model of the neural network multimodal model, a predicted next-token distribution corresponding to the text input, based the one or more text tokens, the first vision tokens and the second vision tokens;
training the neural network multimodal model by updating at least the neural network based language model using a loss objective computed based on the predicted next-token distribution; and
generating, by the trained neural network multimodal model, a response to a question relating to a first input image and a second input image.

9. The system of claim 8, wherein the operation further comprise:
generating, for each of the two input images, a plurality of image patches, wherein each image patch of the plurality of image patches includes a portion of the each input image at substantially similar resolution,
wherein the first vision tokens and the second vision tokens are obtained by: encoding, by the one or more vision encoders, the plurality of image patches into raw vision tokens.

10. The system of claim 9, wherein the operation further comprise:
downsampling, by one or more token samplers, the raw vision tokens corresponding to each image patch, and
concatenating the downsampled raw vision tokens into the first vision tokens and the second vision tokens corresponding to the at least two input images.

11. The system of claim 10, wherein the operation of training neural network multimodal model further comprises:
updating the neural network based language model and the one or more token samplers based on the loss objective via backpropagation while keeping the one or more vision Transformers unchanged.

12. The system of claim 8, wherein the operation of training neural network multimodal model further comprises:
a first stage of pre-training the neural network based language model using a first dataset of training images and corresponding texts, wherein the predicted next-token distribution corresponds to reconstructed text tokens, and the loss objective comprises a first cross-entropy loss between the one or more text tokens the predicted next-token distribution.

13. The system of claim 12, wherein the operation of training neural network multimodal model further comprises:
a second stage of fine-tuning the neural network based language model using a second dataset of at least one training image, a question about the training image, and an answer to the question, wherein the predicted next-token distribution corresponds to predicted text tokens of a predicted answer to the question, and the loss objective comprises a second cross-entropy loss between the predicted text tokens and the answer to the question.

14. The system of claim 13, wherein the operation of training neural network multimodal model further comprises:
a third stage of fine-tuning the neural network based language model using multiple image inputs, and a training question relating to the multiple image inputs.

15. A non-transitory storage process-readable medium storing a plurality of processor-executable instructions for a vision-language task by a neural network multimodal model in response to multiple input images, the instructions being executed by one or more processors to perform operations comprising:
receiving, via a data interface, a text input and at least two input images;
encoding, by a text encoder of the neural network multimodal model, the text input to one or more text tokens;
encoding, by one or more vision encoders of the neural network multimodal model, the at least two input images into at least first vision tokens and second vision tokens, respectively;
generating, by a neural network based language model of the neural network multimodal model, a predicted next-token distribution corresponding to the text input, based the one or more text tokens, the first vision tokens and the second vision tokens;
training the neural network multimodal model by updating at least the neural network based language model using a loss objective computed based on the predicted next-token distribution; and
generating, by the trained neural network multimodal model, a response to a question relating to a first input image and a second input image.

16. The non-transitory storage process-readable medium of claim 1, wherein the operations further comprise:
generating, for each of the two input images, a plurality of image patches, wherein each image patch of the plurality of image patches includes a portion of the each input image at substantially similar resolution,
wherein the first vision tokens and the second vision tokens are obtained by: encoding, by the one or more vision encoders, the plurality of image patches into raw vision tokens.

17. The non-transitory storage process-readable medium of claim 1, wherein the operations further comprise:
downsampling, by one or more token samplers, the raw vision tokens corresponding to each image patch, and
concatenating the downsampled raw vision tokens into the first vision tokens and the second vision tokens corresponding to the at least two input images.

18. The non-transitory storage process-readable medium of claim 17, wherein the operation of training neural network multimodal model further comprises:
updating the neural network based language model and the one or more token samplers based on the loss objective via backpropagation while keeping the one or more vision Transformers unchanged.

19. The non-transitory storage process-readable medium of claim 17, wherein the operation of training neural network multimodal model further comprises:
a first stage of pre-training the neural network based language model using a first dataset of training images and corresponding texts, wherein the predicted next-token distribution corresponds to reconstructed text tokens, and the loss objective comprises a first cross-entropy loss between the one or more text tokens the predicted next-token distribution.

20. The non-transitory storage process-readable medium of claim 19, wherein the operation of training neural network multimodal model further comprises:
a second stage of fine-tuning the neural network based language model using a second dataset of at least one training image, a question about the training image, and an answer to the question, wherein the predicted next-token distribution corresponds to predicted text tokens of a predicted answer to the question, and the loss objective comprises a second cross-entropy loss between the predicted text tokens and the answer to the question.
